(19) United States
(12) Patent Application Publication
(10) Pub. No.: US 2008/0046890 A1
(43) Pub. Date: Feb. 21, 2008

(54) METHOD AND APPARATUS FOR BALANCING WORKLOADS IN A CLUSTER

(76) Inventors: Stanley Steven Dunlap, Fort Mill, SC (US); Marcos Nogueira Novacs, Hopewell Junction, NY (US)

Correspondence Address: DUKE W. YEE, YEE & ASSOCIATES, P.C., P.O. BOX 802333, DALLAS, TX, 75380, US

(21) Appl. No.: 11/465,179

(22) Filed: Aug. 17, 2006

(51) Int. Cl. G06F 9/46

(52) U.S. Cl. 718/104

(57) ABSTRACT

A computer implemented method, apparatus, and computer usable program code for managing a dynamic cluster. Processor usage is monitored in the dynamic cluster, wherein applications execute on partitions in the dynamic cluster. In response to a determination that the processor usage exceeds a threshold level, applications are rebalanced within the dynamic cluster in a manner that reduces processor usage.

### BACKGROUND OF THE INVENTION

1. Field of the Invention

The present invention relates generally to an improved data processing system and in particular to a method and apparatus for managing a cluster. Still more particularly, the present invention relates to a computer implemented method, apparatus, and computer usable program code for workload balancing in dynamic clusters.

2. Description of the Related Art

The Internet is a global network of computers and networks joined together by means of gateways that handle data transfer and the conversion of messages from a protocol of the sending network to a protocol used by the receiving network. On the Internet, any computer may communicate with any other computer with information traveling over the Internet through a variety of languages, also referred to as protocols. The set of protocols used on the Internet is called transmission control protocol/Internet Protocol (TCP/IP).

The Internet has revolutionized communications and commerce, as well as being a source of both information and entertainment. For many users, e-mail is a widely used format to communicate over the Internet. Users also use the Internet to purchase goods and services as well as perform business transactions.

With respect to transferring data over the Internet, the World Wide Web environment is used. This environment is also referred to as “the Web”. The Web is a mechanism used to access information over the Internet. In the Web environment, servers and clients perform data transactions using hypertext transfer protocol (HTTP), a known protocol for handling the transfer of various data files, such as text files, graphic images, animation files, audio files, and video files.

With respect to business transactions and commerce over the Internet, many businesses and organizations have set up websites on the Internet to transact business. Further, organizations also may perform daily business processes using the Internet to send and receive data internally.

As an example, a business may set up a website to present goods and services offered by the business. Further, this website also may serve as a portal to receive orders or requests for goods and services. With many businesses, a single server is often insufficient to handle the amount of traffic that may occur. To solve this problem, a cluster is used to provide a single presence, such that the users do not have to visit a different website to order goods and services.

A cluster is a group of computers that are coupled together to work closely, such that they work together in many respects as a single computer. Clusters are typically, but not always, connected through local area networks. Clusters are typically deployed to improve the speed and reliability over that provided by a single computer.

Moreover, with respect to a website provided by a business or organization, a cluster provides an ability to process more requests and provide for redundancy in the event of a failure of one computer within the cluster. As a result, customers do not encounter slower responses or an unavailability of a website that may occur with a single computer.

A dynamic cluster is a server cluster having two or more nodes and is able to balance workloads dynamically based on performance information collected from the cluster nodes. In a dynamic cluster, applications may be started and stopped during while the dynamic cluster is running. Further, applications may be moved around within the dynamic cluster.

Many different numbers and types of applications may run on a dynamic cluster. Each application runs independently of another application on these types of nodes. Management of these types of clusters and the applications are performed using different mechanisms. These mechanisms typically come from different products. For example, one product may manage the routing requests in the cluster, while another product may manage the starting and stopping of applications on different nodes in the cluster. With these different products, the management of a cluster requires an administrator to be familiar with and use different products which may have different interfaces and different requirements for their proper execution. These types of requirements take time and effort.

### BRIEF SUMMARY OF THE INVENTION

The present invention provides a computer implemented method, apparatus, and computer usable program code for managing a dynamic cluster. Processor usage is monitored in the dynamic cluster, wherein applications execute in the dynamic cluster. In response to a determination that the processor usage exceeds a threshold level, applications are rebalanced within the dynamic cluster in a manner that reduces processor usage.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which illustrative embodiments may be implemented;

FIG. 2 is a block diagram of a data processing system in which illustrative embodiments may be implemented;

FIG. 3 is a diagram of a cluster in accordance with an illustrative embodiment;

FIG. 4 is a diagram illustrating components used to manage a cluster of nodes in accordance with an illustrative embodiment;

FIG. 5 is a diagram of a node in accordance with an illustrative embodiment;

FIG. 6 is a diagram of a controller node in accordance with an illustrative embodiment;

FIG. 7 is a flowchart of a process for managing a cluster in accordance with an illustrative embodiment;

FIG. 8 is a flowchart of a process for moving an application in accordance with an illustrative embodiment;

FIG. 9 is an example of code to get an admin client for a controller node in accordance with an illustrative embodiment;

FIG. 10 is a diagram of code used to obtain access to a management bean in accordance with an illustrative embodiment;

FIG. 11 is an example of code used to register a management bean to receive events in accordance with an illustrative embodiment; and

FIGS. 12A and 12B are diagrams illustrating code used for obtaining performance information in accordance with an illustrative embodiment.

### DETAILED DESCRIPTION OF THE INVENTION

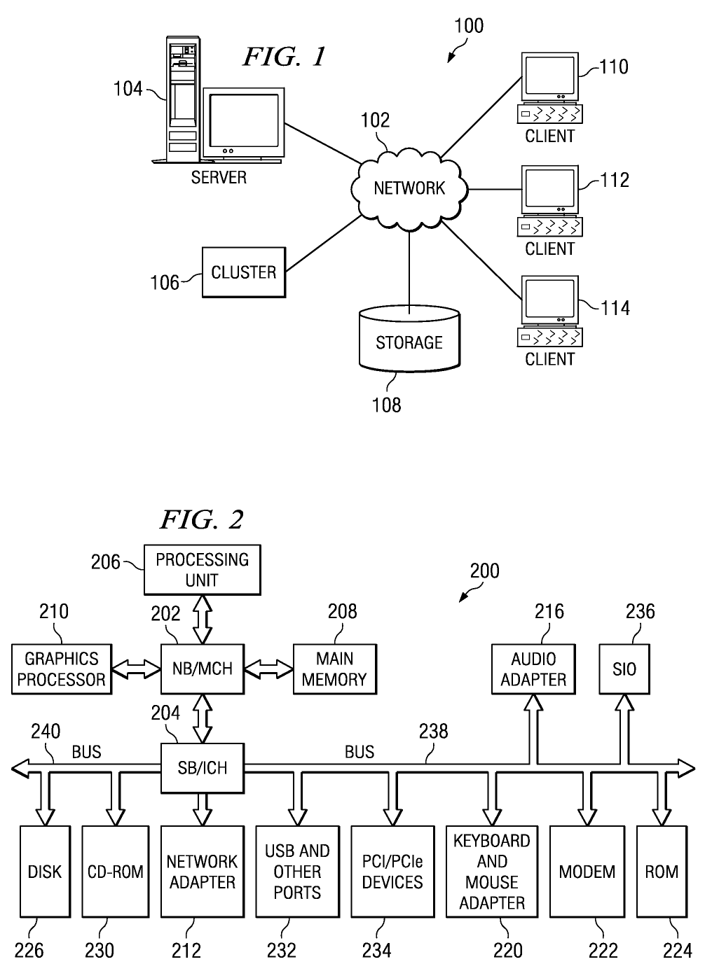

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing systems in which illustrative embodiments may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and cluster 106 connect to network 102 along with storage unit 108. In addition, clients 110, 112, and 114 connect to network 102. These clients 110, 112, and 114 may be, for example, personal computers or network computers. In the depicted example, server computer 104 and cluster 106 provide data, such as boot files, operating system images, and applications to clients 110, 112, and 114. Clients 110, 112, and 114 are clients to server computer 104 and cluster 106 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

With reference now to FIG. 2, a block diagram of a data processing system is shown in which illustrative embodiments may be implemented. Data processing system 200 is an example of a computer, such as server computer 104 or client 110 in FIG. 1, in which computer usable code or instructions implementing the processes may be located for the illustrative embodiments.

In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are coupled to north bridge and memory controller hub 202. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processor 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java™ programs or applications executing on data processing system 200 (Java™ and all Java™-based trademarks are trademarks of Sun Microsystems, Inc. in the United States, other countries, or both).

Instructions for the operating system, the object-oriented programming system, and applications or programs are located on storage devices, such as hard disk drive 226, and may be loaded into main memory 208 for execution by processor 206. The processes of the illustrative embodiments may be performed by processor 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

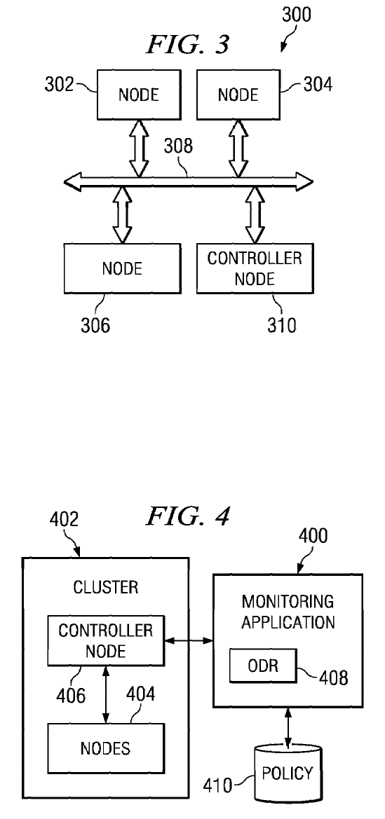

Turning now to FIG. 3, a diagram of a cluster is depicted in accordance with an illustrative embodiment. In this example, cluster 300 is a more detailed example of cluster 106 in FIG. 1. Cluster 300 contains node 302, 304, and 306. These nodes communicate with each other though bus 308. However, the nodes may communicate with each other using any type of communications. Controller node 310 connects to bus 308. This node receives and routes requests to cluster 300 and routes them to nodes 302, 304, and 306. Further, controller node 310 also manages the partitioning of these nodes. Controller node 310 may initiate the formation of partitions on the nodes to allow the partitions to work concurrently to process requests.

Although three nodes are depicted in cluster 300, embodiments may be implemented using other numbers of nodes. For example, cluster 300 may be implemented using two or seven nodes. The actual number of nodes depends on the particular implementation. In these examples, node 302, node 304, node 306 and controller node 310 may be implemented using a data processing system, such as data processing system 200 in FIG. 2.

The present invention provides a computer implemented method, apparatus, and computer usable program product for managing a dynamic cluster. Processor usage in the dynamic cluster is monitored. The applications execute on partitions in the dynamic cluster in these examples. Responsive to a determination that the processor usage exceeds a threshold level, the applications are rebalanced within the dynamic cluster in a manner that reduces processor usage. The rebalancing in these illustrative embodiments involves stopping an application on a node in which usage of processor resources has exceeded a threshold level or value. The application is then started on another node in the cluster.

With reference now to FIG. 4, a diagram illustrating components used to manage a cluster of nodes is depicted in accordance with an illustrative embodiment. In this example, monitoring application 400 is employed to manage cluster 402, which contains nodes 404 and controller node 406. Cluster 402 may be implemented using cluster 300 in FIG. 3. In the illustrative examples, monitoring application 400 is a software component that executes on a data processing system separate from those of cluster 402. Of course, depending on the particular implementation, monitoring application 400 may execute on one of the data processing systems within cluster 402.

Monitoring application 400 receives data from controller node 406. This data, in these examples, takes the form of processor usage on processors within nodes 404. The data also may include events, such as the starting and stopping of partitions and the starting and stopping of applications within nodes 404.

In these illustrative examples, monitoring application 400 uses this data to start and stop applications and partitions in nodes 404 in a manner that provides for more efficient routing of requests by a in controller node 406. In this example, the router is on-demand router (ODR) 408.

The actions taken are applied based on policy 410. This policy contains various rules and parameters used to determine when processor usage may be too high in a particular partition. In these examples, a node will have one or more applications running on it and that node may have several partitions running in which the applications execute. When an application is stopped on a busy node and a new instance of the application is started on another node, the partition in which the application is location is moved as well to the new node, in these examples. Further, policy 410 is also used to determine when to rebalance or redistribute the execution of applications within different partitions in node 404.

In these examples, only one instance of an application runs any particular partition in a node. In this manner, the application may service a particular client. As a result, if an application is not running optimally on a particular partition or if an application has stopped, the application is started on another partition in these examples.

In addition to rebalancing applications and partitions based on processor usage, monitoring application 400 also may rebalance partitions when an application is started or stopped. This type of rebalancing also may occur in response to a server starting and stopping as well as the starting and stopping of applications. A server as used herein is a software application which is a host in which other applications run. The server provides basic services to applications and allows applications to use other resources such as databases. Other events also may be used in addition to these.

Monitoring application 400 initiates these changes by sending commands back to controller node 406. In turn, controller node 406 then implements the starting and stopping of partitions and application on different nodes within nodes 404. Through this rebalancing of partitions based on processor usage and start and stop events in nodes 404, monitoring application 400 provides for workload balancing within cluster 402 in the manner that helps facilitate the routing of requests by on-demand router 408.

In this manner, on-demand router 408 may continue to route requests based on service level agreements based on the rate at which requests are processed. As a result, on-demand router 408 does not need to know or react to the use of resources and different start and stop events occurring within node 404.

Further, the use of this type of workload balancing for a cluster, such as cluster 402, does not require changes to the software components used within cluster 402. Monitoring application 400 requests data and sends commands to controller node 406 to implement functions already present within controller 406. For example, controller node 406 already has functions that are used to start and stop applications, partitions, and servers within nodes 404. An example of such a product is WebSphere Extended Deployment, which is a set of functions present in WebSphere application servers and is available from International Business Machines Corporation.

Additionally, clusters may use an on-demand router (ODR) that decides how to route requests. An on-demand router determines whether sufficient application resources are available to support the work needed to process the requests. On-demand routers route information based on requests as the come in. These routers use service level agreements to ensure that requests from certain clients are processed within a selected amount of time.

A dynamic cluster may be expanded or contracted depending on the requests that are being received for processing. This expanding and contracting refers to increasing and decreasing applications running on a node. Further, in a dynamic cluster, applications may be started and stopped as needed to process requests and other work. The management of a dynamic cluster is managed using a high availability manager. The different illustrative embodiments recognize that this type of manager is found in a different type of software product for managing clusters from that of an on-demand router. This component is used to enforce runtime behavior and policies for a partition. A high availability manager manages groups of application servers and partitions.

As different members or nodes in a cluster stop, start, or fail, this manager adjusts the partitions in the nodes. The adjustments may be made based on the current state of the cluster and on a policy. In these examples, this policy is a set of rules that define how the cluster should be run and changes that should occur based on different states. The different adjustment made by a high availability manager is based on the number of cycles used in a processor.

The illustrative embodiments recognize that a routing component, such as an on-demand router, requires information in the form of the rate at which requests are processed to route requests to different nodes in the cluster. The illustrative embodiments also recognize that a management component, such as a high availability manager, generates information in the form of processor usage. This information may be, for example, the number of processor cycles used over a certain period of time or a percentage of processor resources used. This type of information, generated by application management components, is unusable by routing mechanisms because they require information in the form of request processing rates rather than processor usage.

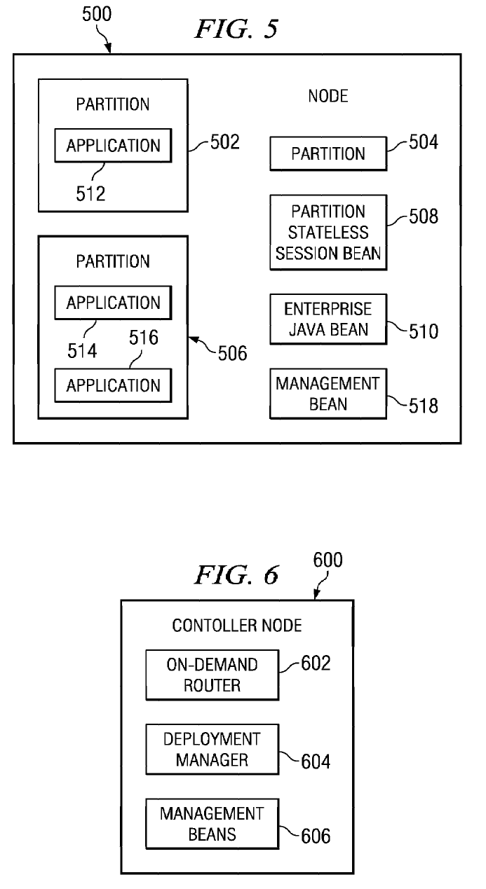

Turning now to FIG. 5, a diagram of a node is depicted in accordance with an illustrative embodiment. In this example, node 500 is an example of a node, such as node 302 of FIG. 3. Node 500 contains partitions 502, 504, and 506. In these illustrative examples, the different components in a node are implemented using various software components. These software components include beans. A bean is a reusable software component in these examples. Node 500 also contains partition stateless session bean 508, enterprise Java™ bean 510, and management bean 518.

Each of these partitions has a different address space. A partition may have one or more applications executing within the partition. For example, partition 502 has application 512. Partition 504 currently has no applications executing. Partition 506 has applications 514 and 516. These applications may take various forms. For example, the application may be a database application to respond to requests containing queries. These applications also may be, for example, applications used to facilitate the sale of goods or services. The applications in this type of an example may be a shopping cart or other construct used to receive and process orders.

In this example, partition stateless session bean 508 is employed to manage partitions, such as partitions 502, 504 and 506. Partition stateless session bean 508 is a stateless session bean that performs activities such as creating deleting, and balancing partitions. A session bean represents a single client in a server, such as an application server. To access an application that is deployed on a server, a client invokes methods in the session bean. The session bean performs the work for the client and reduces the complexity of the client by executing different tasks inside the server. A stateless session bean does not maintain the conversation of state for the client.

When a client invokes a method of a stateless session bean, the bean's instant variables may contain a state, but only for the duration of the invocation. When the execution of the method completes, the state is no longer retained. Except during the actual invocation, all instances of the stateless bean are equivalent allowing the assignment of an instance to any client that makes a request. In this manner, stateless session beans may support multiple clients allowing for better scalability for applications to service large numbers of clients.

Enterprise Java™ bean 510 is an application resource that performs application specific tasks. These tasks include, for example, create checking account, create customer, find customer, and delete customer. Enterprise Java™ bean 510 also may perform anything from reading and writing of information to and from a database or creating accounts for customers in an online banking application. For an online purchasing application, enterprise Java™ bean 510 may create customer accounts, receive orders, and initiate processing of orders.

Node 500 also includes management bean 518. Management bean 518 is a component used to interact with a controller node, such as controller node 406 in FIG. 4. This management bean sends data regarding the processor usage on node 500 to the controller node. Further, management bean 518 also sends different start and stop events occurring within node 500. These events may include, for example, start and stop events for servers and applications executing in node 500.

Management bean 518 also may receive commands from a controller node to start and stop applications, such as those found on partitions 502 and 506. For example, management bean 518 may receive a command from a controller node to stop application 514 on partition 506 and restart application 514 on partition 504. By moving application 514 from partition 506 to partition 504, the amount of processor resources utilized in partition 506 is reduced because fewer applications are executing on the partition, assuming that the applications are actively processing requests.

Turning now to FIG. 6, a diagram of a controller node is depicted in accordance with an illustrative embodiment. In this example, controller node 600 is an example of controller node 310 in FIG. 3. In these illustrative examples, controller node 600 includes on-demand router 602. In these illustrative embodiments, on-demand router 602 serves as a reverse proxy between the client and an application in the cluster. On-demand router 602 extracts the partition in from the received HTTP request and routes it to the application server that hosts the particular instance of the application that is serving the partition. This type of partitioning function ensures that requests are routed to the correct server, even in the circumstance when a partition is unloaded from one server and loaded into another.

On-demand router 602 routes demands based on receiving information as to the rate at which requests are processed, such as requests per second. On-demand router 602 and other routing mechanisms used to route requests from clients are unable to perform these types of routing processes to balance workloads based on information regarding resources usage within nodes in a cluster.

Controller node 600 also contains deployment manager 604. This component is used to manage resources within the nodes in a cluster. Deployment manager 604 may be used to initialize partitions on the different nodes when the servers are started. Further, deployment manager 604 may be employed to start and stop applications and servers on the different nodes. The functions provided by deployment manager may be found in WebSphere extended deployment functions currently used in WebSphere application servers available from International Business Machines Corporation.

Additionally, controller node 600 also contains management beans 606. These beans are components used to provide interaction between controller node 600 and other nodes within the cluster. Management beans 606 receives information from the nodes. This information includes, for example, processor usage, and events occurring on the nodes.

In these examples, the events received by management beans 606, includes start and stop events for applications and servers. Further, management beans 606 also provide an interface to receive information and commands from sources external to the cluster. In these illustrative examples, this interface is used by a monitoring application, such as monitoring application 400 in FIG. 4.

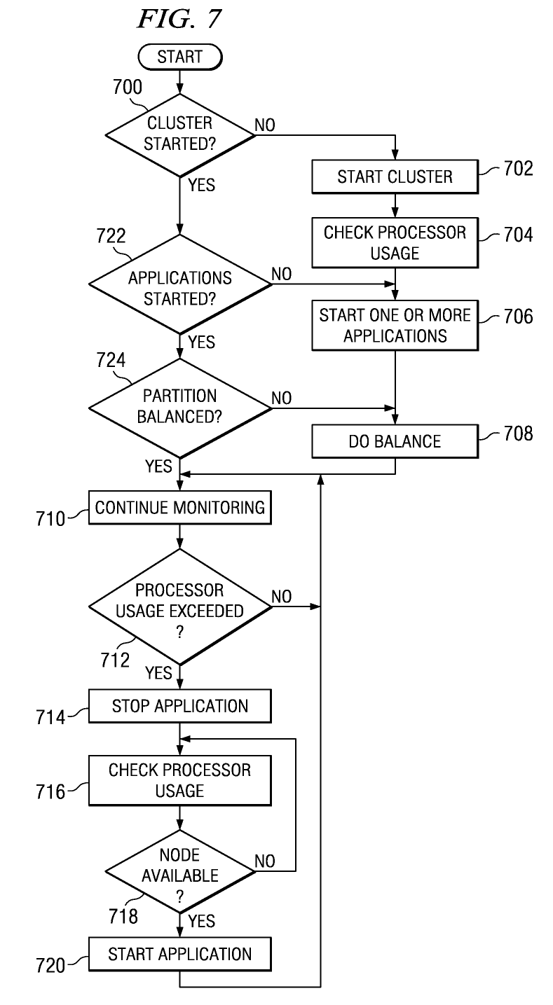

Turning now to FIG. 7, a flowchart of a process for managing a cluster is depicted in accordance with an illustrative embodiment. The process illustrated in FIG. 7 may be implemented in a monitoring application, such as monitoring application 400 in FIG. 4. The different steps in this illustrative flowchart are used to monitor for different events and processor usage on the nodes. In response to receiving this information, the process may balance applications on the nodes to provide for better workflow balancing within the cluster.

The process begins by determining whether a cluster has started (step 700). If the cluster has not started in step 700, the cluster is started (step 702). Processor usage on the servers is checked (step 704). One or more applications are started (step 706). Next, a balance is performed (step 708) and monitoring continues (step 710). Balancing in step 708 is performed to ensure that the applications use the processor resources evenly in these illustrative examples. This step is used because when a cluster starts and the applications are initially started in the cluster, the applications are started randomly. Thus, some nodes may have many applications running, while other nodes may have only one or no applications running.

The balancing may be performed using any known method or technique for balancing use of resources in a cluster. The balancing may be performed to ensure that even usage of processor and/or other resources occurs in the cluster. The monitoring in these examples is for processor usage by different servers in the cluster. The process may monitor for any event of interest. In these examples, the process monitors to detect a server start events, server stop events, application start events, application stop events, and for processor usage on the different nodes. The process in this example is interested in application start events.

When an application step event is detected in step 710, the process then determines if processor usage is exceeded on the node on which the application has been started (step 712). In these examples, the processor usage is exceeded if the usage is greater than a selected threshold. For example, the threshold may be set at 90 percent of the processor. Although the depicted embodiments use the same threshold for all of the nodes, different threshold values may be assigned to different nodes. Also, different thresholds may be used based on other factors, such as, for example, a time of day or a particular day of the week. If processor usage has been exceeded in step 712, the application is stopped (step 714).

Thereafter, a check of processor usage is made on all of the nodes (step 716). A determination is made as to whether a node is available to start the application based on the processor usage (step 718). If a node is available, the application is started on that node (step 720) and the process then returns to step 710 as described above. In step 718, an available node is a node that has the least processor usage if more than one node can be used to start the application in these examples. Of course other selection methods may be used depending on the particular implementation.

With reference again to step 718, If a node is not available, the process loops back to step 716 to check processor usage on the nodes until a node does become available. In these examples, steps 714, 716, 718, and 720 are employed to rebalance applications when processor usage is exceeded on a node when an application is started on that node. Similar, steps may be performed if monitoring for processor usage is for other events or performed constantly.

Turning back to the initial decision made at step 700, if the process determines that the cluster has started, the process further determines if the applications have started (step 722). If the applications have started in step 722, the process determines if the partition is balanced (step 724). If the process determines the partition is balanced in step 724, the process returns to step 710 to continue monitoring. If the process determines the partition is not balanced in step 724, the process returns to step 708 to perform a balance.

Turning back to the decision made at step 722, if the process determines the applications have not started, the process returns to step 706 to start one or more of the applications.

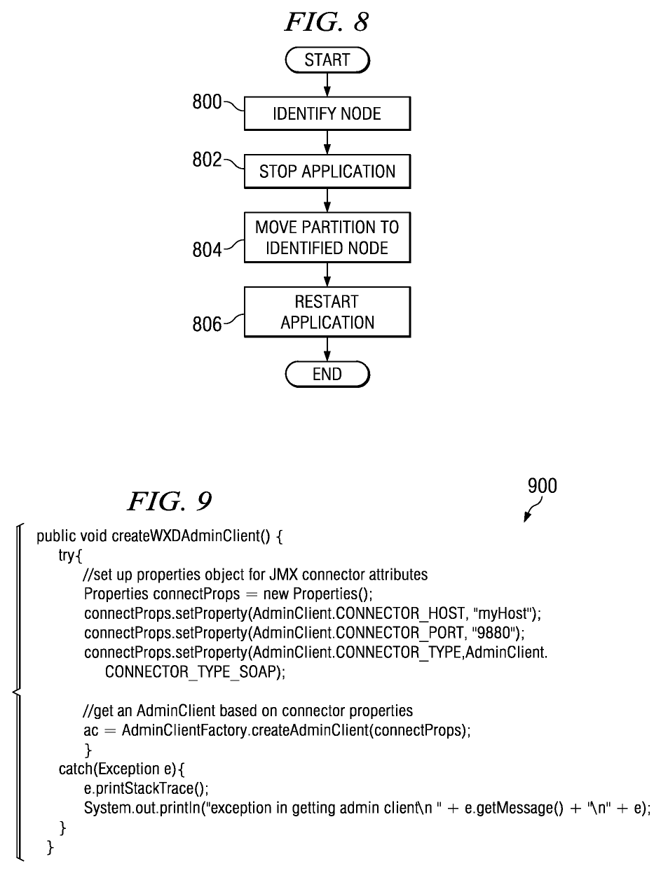

Turning now to FIG. 8, a flowchart of a process for moving an application is depicted in accordance with an illustrative embodiment. The steps illustrated in FIG. 8 may be implemented in a software component, such as monitoring application 400 in FIG. 4. For various steps involving the manipulation of applications and partitions, the monitoring application sends commands to a controller node to initiate the different functions used to start and stop applications.

The process begins by identifying a node (step 800). Next the application is stopped (step 802) and the partition is moved to the identified node (step 804). Finally, the application is restarted (step 806) with the process terminating thereafter.

Turning now to FIG. 9, an example of code to get an admin client for a controller node is depicted in accordance with an illustrative embodiment. In this example, code 900 is an example of code that is used to obtain an interface to administrative functions on the controller node to control application servers. This is an example of code that may be implemented in a monitoring application, such as monitoring application 400 in FIG. 4 to interface with a controller node.

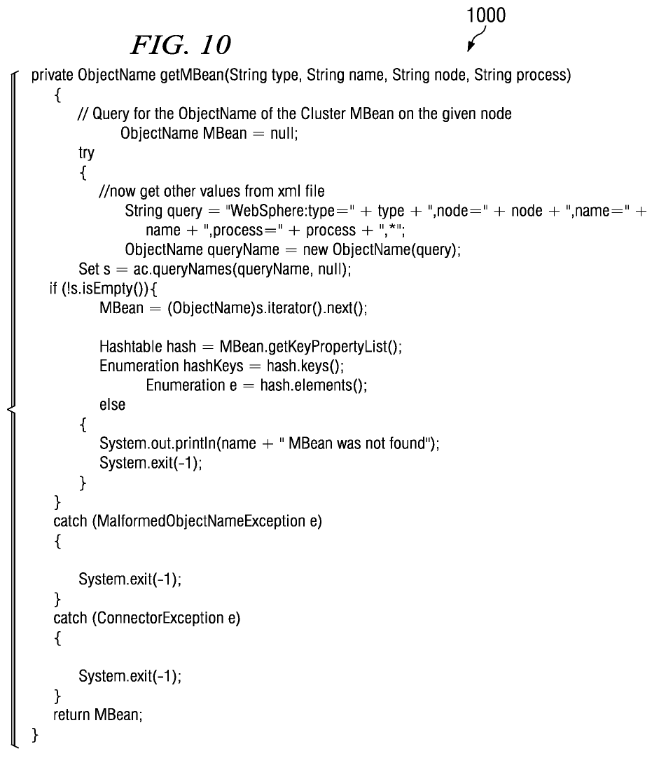

Turning now to FIG. 10, a diagram of code used to obtain access to a management bean is depicted in accordance with an illustrative embodiment. Code 1000 is an example of code that may be implemented to obtain access to a management bean on a controller node, such as a management bean in management beans 606 in FIG. 6. After obtaining access to the management bean in a controller node, the management bean is registered to receive application events.

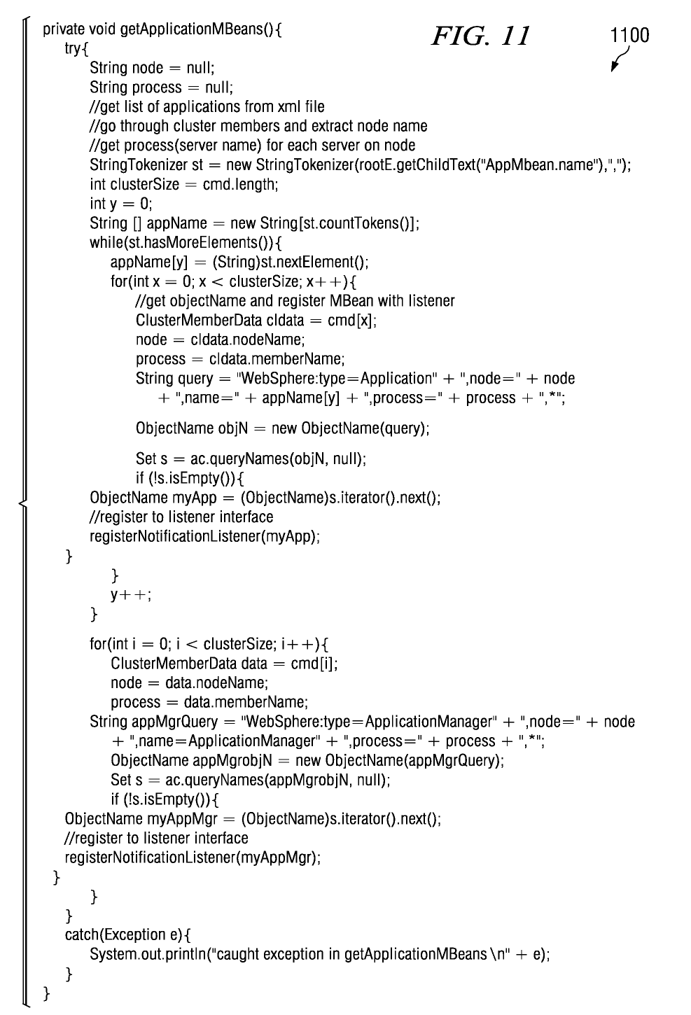

Turning now to FIG. 11, an example of code used to register a management bean to receive events is depicted in accordance with an illustrative embodiment. Code 1100 is used to register the management bean to obtain information for events, such as the starting and stopping of servers.

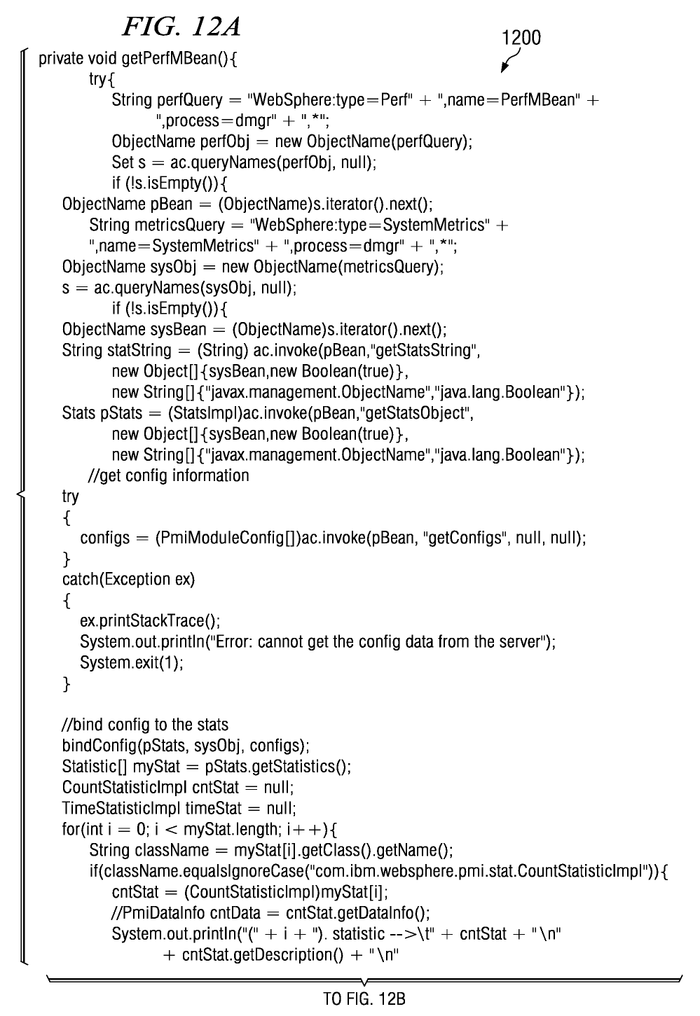

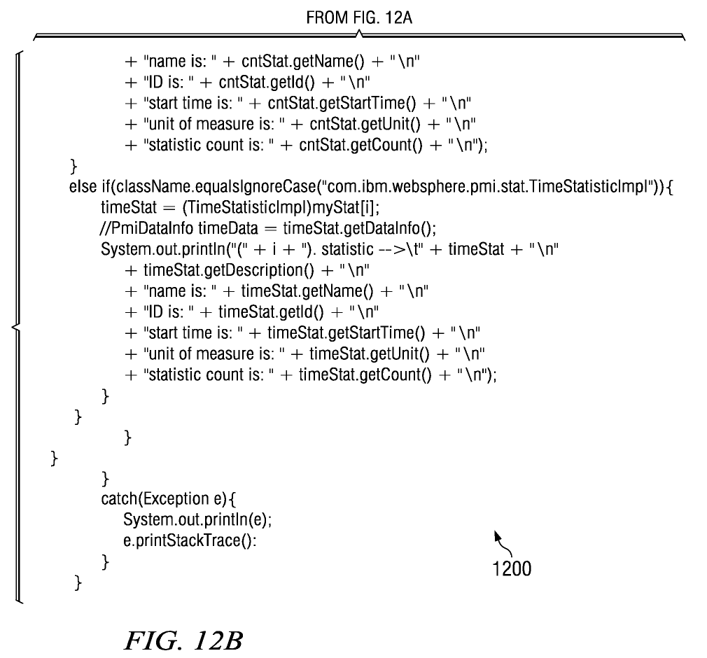

Turning now to FIGS. 12A and 12B, diagrams illustrating code used for obtaining performance information are depicted in accordance with an illustrative embodiment. Code 1200 is an example of code that is used to obtain performance information from a management bean. The performance information is processor usage.

Thus, the present invention provides a computer implemented method, apparatus, and computer usable program code for managing nodes in a cluster. The different illustrative embodiments use a monitoring application to determine when a selected event occurs in a cluster, such as cluster 300 in FIG. 3. Based on identifying events, such as, for example, server start and stop events, application start and stop events and processor usage, the monitoring application initiates balancing of the applications. With the balancing of applications, the different embodiments enable more efficient routing of requests by a routing component.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for managing a dynamic cluster, the computer implemented method comprising:
monitoring processor usage in the dynamic cluster, wherein applications execute on partitions in the dynamic cluster; and
responsive to a determination that the processor usage exceeds a threshold level, rebalancing the applications within the dynamic cluster in a manner that reduces processor usage.

2. The computer implemented method of claim 1, wherein the monitoring step comprises:
monitoring for an event indicating that an application has started on a node; and
responsive to detecting the start event, determining whether processor usage on the node has exceeded the threshold level.

3. The computer implemented method of claim 2, wherein the balancing step comprises:
stopping the application;
identifying a new node on which processor resources have not exceeded the threshold; and
starting the application on the new node.

4. The computer implemented method of claim 1, wherein the application executes in a partition in the node and wherein the rebalancing step comprises:
stopping execution of the application in the node; and
restarting execution of the application in another node after stopping execution of the application.

5. The computer implemented method of claim 1, wherein the processor usage is a percentage of the processor being used.

6. The computer implemented method of claim 1, wherein a management bean is used to monitor the cluster and rebalance the applications in the dynamic cluster.

7. A dynamic cluster comprising:
a plurality of nodes;
a controller node, wherein the controller node routes requests to applications executing in the plurality of partitions; and
a monitoring application, wherein the monitoring application monitors processor usage as the applications process the requests, and rebalances the applications in response to processor usage exceeding a threshold level in one of the plurality of nodes to reduce processor usage.

8. The dynamic cluster of claim 7, wherein the monitoring application is located on a data processing system in communication with the controller node.

9. A computer program product comprising:
a computer usable medium having computer usable program code for managing a dynamic cluster, the computer program medium comprising:
computer usable program code for monitoring processor usage in the dynamic cluster, wherein applications execute on partitions in the dynamic cluster; and
computer usable program code, responsive to a determination that the processor usage exceeds a threshold level, for rebalancing the applications within the dynamic cluster in a manner that reduces processor usage.

10. The computer program product of claim 9, wherein monitoring processor usage in the dynamic cluster, wherein applications execute on partitions in the dynamic cluster comprises:
computer usable program code for monitoring for an event indicating that an application has started on a node; and
computer usable program code, responsive to detecting the start event, determining whether processor usage on the node has exceeded the threshold level.

11. The computer program product of claim 10, wherein responsive to a determination that the processor usage exceeds a threshold level, rebalancing the applications within the dynamic cluster in a manner that reduces processor usage comprises:
computer usable program code for stopping the application;
computer usable program code for identifying a new node on which processor resources have not exceeded the threshold; and
computer usable program code for starting the application on the new node.

12. The computer program product of claim 9, wherein the application executes in a partition in the node and wherein the computer usable program code, responsive to a determination that the processor usage exceeds a threshold level, for rebalancing the partitions within the dynamic cluster in a manner that reduces processor usage comprises:
computer usable program code for stopping execution of the application in the node; and
computer usable program code for restarting execution of the application in another node after stopping execution of the application.

13. The computer program product of claim 9, wherein the processor usage is a percentage of the processor being used.

14. The computer program product of claim 9, wherein a management bean is used to monitor the cluster and rebalance the applications in the dynamic cluster.

15. A data processing system comprising:
a bus;
a communications unit connected to the bus;
a storage device connected to the bus, wherein the storage device includes computer usable program code; and
a processor unit connected to the bus, wherein the processor unit executes the computer usable program code to monitor processor usage in the dynamic cluster, wherein applications execute on partitions in the dynamic cluster; and rebalance the applications within the dynamic cluster in a manner that reduces processor usage in response to a determination that the processor usage exceeds a threshold level.

16. The data processing system of claim 15, wherein monitoring processor usage in the dynamic cluster, wherein applications execute on partitions in the dynamic cluster, the processor unit executes computer usable program code to monitor for an event indicating that an application has started on a node; and determine whether processor usage on the node has exceeded the threshold level in response to detecting the start event.

17. The data processing system method of claim 16, wherein rebalancing the applications within the dynamic cluster in a manner that reduces processor usage in response to a determination that the processor usage exceeds a threshold level, the processor unit executes computer usable program code to stop the application; identify a new node on which processor resources have not exceeded the threshold; and start the application on the new node.

18. The data processing system of claim 15, wherein the application executes in a partition in the node and wherein rebalancing the partitions within the dynamic cluster in a manner that reduces processor usage in response to a determination that the processor usage exceeds a threshold level, the processor unit executes computer usable program code to stop execution of the application in the node; and to restart execution of the application in another node after stopping execution of the application.

19. The data processing system of claim 15, wherein the processor usage is a percentage of the processor being used.

20. The data processing system of claim 15, wherein a management bean is used to monitor the cluster and rebalance the applications in the dynamic cluster.
